(19) United States
(12) Patent Application Publication
(10) Pub. No.: US 2018/0370640 A1
(43) Pub. Date: Dec. 27, 2018

(54) AIRCRAFT

(71) Applicant: PANASONIC INTELLECTUAL PROPERTY MANAGEMENT CO., LTD., Osaka (JP)

(72) Inventors: Masayuki TOYAMA, Kanagawa (JP); Naoto YUMIKI, Osaka (JP); Atsuhiro TSUJI, Osaka (JP); Hiroyuki MATSUMOTO, Tokyo (JP)

(21) Appl. No.: 16/107,666

(22) Filed: Aug. 21, 2018

Related U.S. Application Data
(63) Continuation of application No. PCT/JP2017/006277, filed on Feb. 21, 2017.

(30) Foreign Application Priority Data
Mar. 10, 2016 (JP) 2016-047416

(51) Int. Cl. B64D 25/00; B64C 27/08; B64C 11/00; B64C 25/56

(52) U.S. Cl. CPC B64D 25/00; B64C 27/08; B64C 11/001; B64C 39/024; B64C 2201/027; B64C 2201/127; B64C 25/56

(57) ABSTRACT

An aircraft includes: a plurality of rotor units each including a propeller and a motor that drives the propeller; a bag-shaped body including a chamber; and an injector that injects gas into the chamber to inflate the bag-shaped body. The bag-shaped body covers at least one of the plurality of rotor units when inflated.

### CROSS REFERENCE TO RELATED APPLICATIONS

This application is a U.S. continuation application of PCT International Patent Application Number PCT/JP2017/006277 filed on Feb. 21, 2017, claiming the benefit of priority of Japanese Patent Application Number 2016-047416 filed on Mar. 10, 2016, the entire contents of which are hereby incorporated by reference.

### BACKGROUND

### 1. Technical Field

The present disclosure relates to an aircraft including a rotor unit.

### 2. Description of the Related Art

Japanese Unexamined Patent Application Publication No. H04-022386 discloses an aircraft including: a single rotor unit including a propeller; and a buoyant body filled with helium gas. In the aircraft disclosed in Japanese Unexamined Patent Application Publication No. H04-022386, the donut-shaped buoyant body is disposed so as to surround the surrounding area of the single rotor unit.

### SUMMARY

The present disclosure provides an aircraft that inhibits a reduction in mobility during flight resulting from air resistance produced by a bag-shaped body filled with gas, such as a buoyant body.

An aircraft according to the present disclosure includes: a plurality of rotor units each including a propeller and a motor that drives the propeller; a bag-shaped body including a chamber; and an injector that injects gas into the chamber to inflate the bag-shaped body. The bag-shaped body covers at least one of the plurality of rotor units when inflated.

With the aircraft according to the present disclosure, it is possible to inhibit a reduction in mobility during flight caused by the bag-shaped body.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a perspective view of the aircraft according to Embodiment 1 in one state from above;

FIG. 2 is a plan view of the aircraft illustrated in FIG. 1 from above;

FIG. 3 is a perspective view of the aircraft according to Embodiment 1 in another state from above;

FIG. 4 is a plan view of the aircraft illustrated in FIG. 3 from above;

FIG. 5 is a cross-sectional view of the aircraft taken at line V-V in FIG. 2;

FIG. 6 is a block diagram illustrating components included in the aircraft according to Embodiment 1;

FIG. 7 is an enlarged perspective view of a first type of rotor unit among the four rotor units included in the aircraft illustrated in FIG. 2;

FIG. 8 is an enlarged perspective view of a second type of rotor unit among the four rotor units included in the aircraft illustrated in FIG. 2;

FIG. 9 is a cross-sectional view of the aircraft taken at line IX-IX in FIG. 4;

FIG. 10 is a perspective view of the aircraft according to Embodiment 2, similar to the view of FIG. 1;

FIG. 11 is a perspective view of the aircraft according to Embodiment 2, similar to the view of FIG. 3;

FIG. 12 is a cross-sectional view of the aircraft according to Embodiment 2, similar to the view of FIG. 9;

FIG. 13 is a cross-sectional view of a variation of the aircraft according to Embodiment 1, similar to the view of FIG. 9; and

FIG. 14 is a perspective view of another variation of the aircraft according to Embodiment 1, similar to the view of FIG. 3.

### DETAILED DESCRIPTION OF THE EMBODIMENTS

Hereinafter, embodiments will be described in detail with reference to the drawings when appropriate. However, unnecessarily detailed description may be omitted. For example, detailed descriptions of well-known matters or descriptions of components that are substantially the same as components described previous thereto may be omitted. This is to avoid unnecessary redundancy and provide easy-to-read descriptions for those skilled in the art. Moreover, in the following descriptions of the embodiments, language accompanied by the terminology “approximately” and “substantially” as used in, for example, “substantially parallel” and “substantially perpendicular,” is used. For example, “substantially parallel” includes, in addition to exactly parallel, essentially parallel, that is to say, for example, includes a margin of error of about a few percent. This also applies to other language accompanied by “approximately” or “substantially”. Note that the accompanying drawings and subsequent description are provided by the inventors to facilitate sufficient understanding of the present disclosure by those skilled in the art, and are thus not intended to limit the scope of the subject matter recited in the claims.

### Embodiment 1

### (1-1. Aircraft Configuration)

### (1-1-1. Overall Aircraft Configuration)

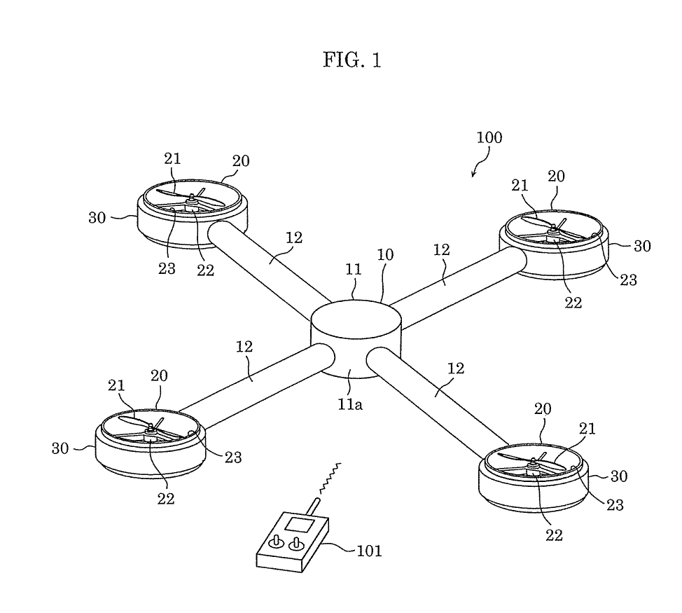

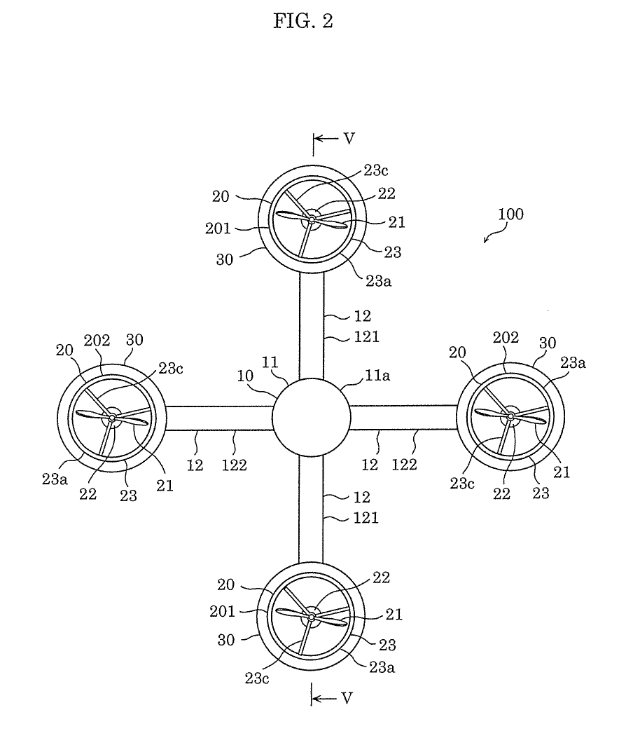

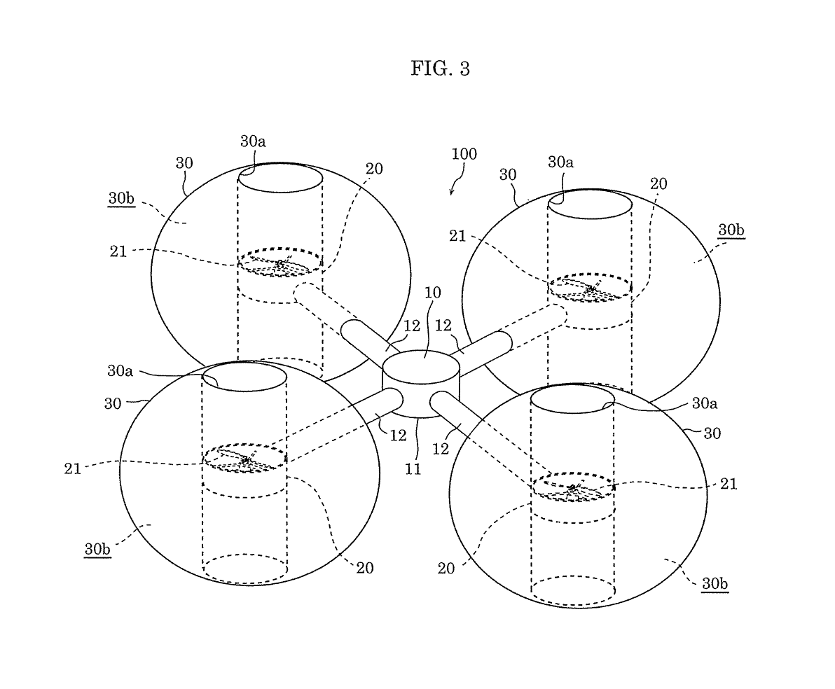

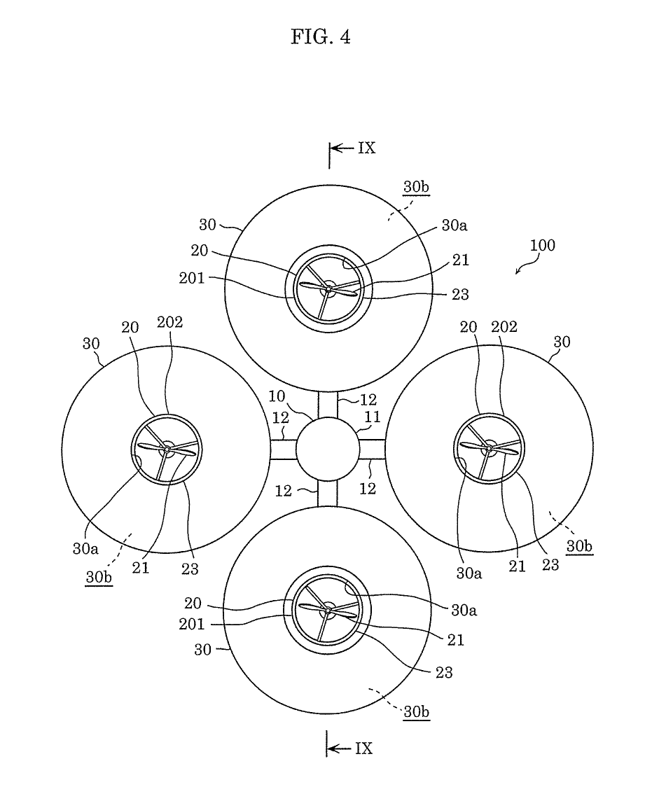

Hereinafter, the overall configuration of aircraft 100 according to Embodiment 1 will be described with reference to FIG. 1 through FIG. 4. FIG. 1 is a perspective view of aircraft 100 according to Embodiment 1 in one state from above. FIG. 2 is a plan view of aircraft 100 illustrated in FIG. 1 from above. FIG. 3 is a perspective view of aircraft 100 according to Embodiment 1 in another state from above. FIG. 4 is a plan view of aircraft 100 illustrated in FIG. 3 from above. FIG. 1 and FIG. 2 illustrate aircraft 100 in a state in which balloons 30, which will be described later, are deflated and stored, and FIG. 3 and FIG. 4 illustrate aircraft 100 in a state in which balloons 30 are inflated.

As illustrated in FIG. 1 through FIG. 4, aircraft 100 according to this embodiment includes frame 10, four rotor units 20 provided to frame 10, and balloons 30 as a bag-shaped body, which are capable of being inflated and deflated, respectively provided to rotor units 20. In this embodiment, aircraft 100 wirelessly communicates with steering controller 101 disposed apart from aircraft 100, and operates in accordance with a command signal transmitted from steering controller 101, but this example is not limiting. Frame 10 includes main body 11 having the shape of a cylinder with both ends closed, and four hollow rod-shaped arms 12. Main body 11 and arms 12 are integral. The four arms 12 extend radially outward from the outer circumferential surface of cylindrical lateral wall 11a of main body 11. The four arms 12 are disposed approximately equidistant from each other along the outer circumferential direction of lateral wall 11a of main body 11, and collectively have a plan view shape of a cross. Note that a plan view shape refers to the shape as seen when aircraft 100 is viewed looking down the axis of the cylindrical main body 11. The four rotor units 20 are fixed to the distal ends of the four arms 12, respectively. Accordingly, each of the four rotor units 20 is disposed in a different one of four spaces delimited by lines that intersect at approximately 90 degrees at a point centered on main body 11. Note that the arrangement of the four rotor units 20 is not limited to the above example. Here, balloon 30 is one example of the first bag-shaped body.

Each rotor unit 20 includes propeller 21, motor 22 that rotationally drives propeller 21, and cylindrical rotor frame 23 that supports motor 22 therein. Each rotor frame 23 is fixed to a different one of arms 12. The four rotor units 20 are disposed such that the planes of rotation of propellers 21 are all oriented in the same direction, that is to say, such that the axes of rotation of propellers 21 are substantially parallel with one another. Balloons 30 are attached on the cylindrical outer circumferential surface 23a of each rotor frame 23 so as to surround outer circumferential surface 23a. As illustrated in FIG. 1 and FIG. 2, balloons 30 are equipped on rotor frames 23 typically in a deflated and folded state. As illustrated in FIG. 3 and FIG. 4, balloons 30 can be inflated by being filled with gas.

### (1-1-2. Frame and On-board Components)

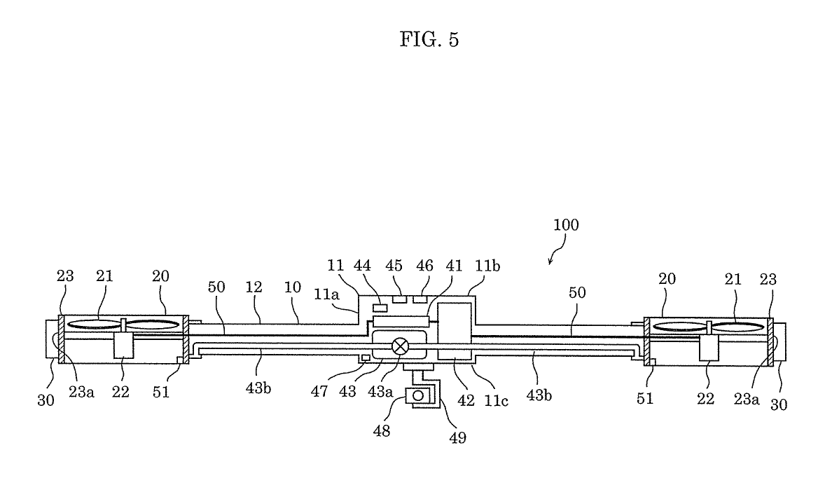

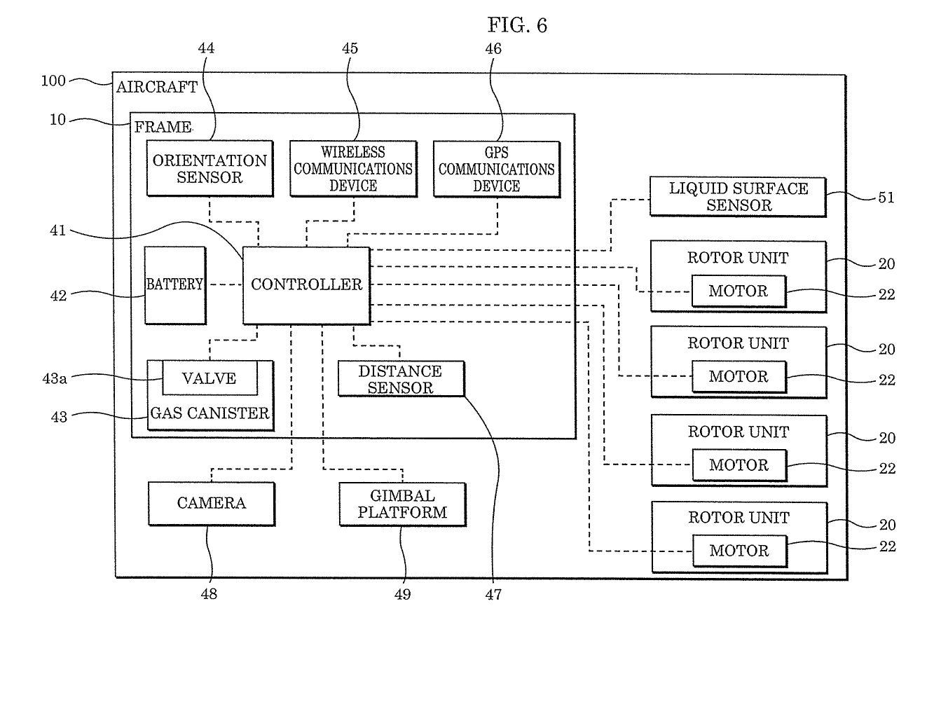

Frame 10 of aircraft 100 and components on-board frame 10 will be described with reference to FIG. 1, FIG. 2, FIG. 5, and FIG. 6. Note that FIG. 5 is a cross-sectional view of aircraft 100 taken along line V-V in FIG. 2, and is a view of a cross section taken along the axis of main body 11 and passing through the center of two arms 12 disposed opposite one another across main body 11 in frame 10 of aircraft 100 illustrated in FIG. 2. FIG. 6 is a block diagram illustrating components included in aircraft 100 according to Embodiment 1.

As illustrated in FIG. 1, FIG. 2, FIG. 5, and FIG. 6, controller 41, battery 42, gas canister 43, and orientation sensor 44 are equipped in main body 11 of frame 10. Furthermore, wireless communications device 45 and global positioning system (GPS) communications device 46 are provided on end wall 11b of main body 11. Distance sensor 47 is provided on end wall 11c of main body 11. Furthermore, gimbal platform 49 of camera 48 is attached to the outer surface of end wall 11c. End walls 11b and 11c are two circular plate-shaped end walls that close both ends of cylindrical lateral wall 11a of main body 11. Aircraft 100 normally flies with end wall 11b on the top and end wall 11c on the bottom. Here, GPS communications device 46 is one example of the positioning device.

Battery 42 is a rechargeable secondary battery, and a power source for aircraft 100. Battery 42 may be any secondary battery, such as a lithium-ion battery, a sodium-ion battery, a nickel-metal hydride battery, a nickel-cadmium battery, or capacitor. Any battery such as a dry-cell battery or primary battery may be used in place of battery 42 as a power source for aircraft 100.

Gas canister 43 stores gas to be injected in balloons 30 of aircraft 100. The filling and dispensing port on gas canister 43 is provided with valve 43a that controls the filling of gas into gas canister 43 and the dispensing of gas from gas canister 43. When gas canister 43 is hermetically sealed by valve 43a, compressed gas is filled therein. Gas may be filled in gas canister 43 in a vaporized state, as a mixture of gas and liquid, or in a liquefied state. However, when gas is dispensed from gas canister 43, it is in a vaporized state or a mixture of gas and liquid. The type of gas used is not particularly limited. For example, the gas may be the atmosphere, may be gas having a higher specific gravity than the atmosphere, such as carbon dioxide, and may be gas having a lower specific gravity than the atmosphere, such as helium. Here, gas canister 43 and valve 43a are one example of the injector.

Valve 43a may be a solenoid valve (also referred to as an electromagnetic valve) and may be a mechanical valve that is actuated by an actuator. Valve 43a is connected to balloons 30 on the four rotor units 20 via pipes 43b (see FIG. 5) routed through the four hollow arms 12 of frame 10. Valve 43a functions as a switching valve. More specifically, valve 43a operates by selecting a first valve state, a second valve state, or a third valve state. In the first valve state, valve 43a places gas canister 43 and pipes 43b in fluid communication. In the second valve state, valve 43a shuts off fluid communication between gas canister 43 and pipes 43b, and hermetically seals gas canister 43 and pipes 43b. In the third valve state, valve 43a shuts off fluid communication between gas canister 43 and pipes 43b, hermetically seals gas canister 43, and opens pipes 43b to the atmosphere. Note that the states of valve 43a may be achieved by a single valve included in valve 43a, and may be achieved by a plurality of valves included in valve 43a.

Orientation sensor 44 detects the orientation of frame 10, that is, the orientation of aircraft 100. Orientation sensor 44 includes, for example, an angular acceleration sensor and a three-axis gyrosensor (also referred to as a three-axis angular speed sensor). Based on, for example, the three-axis acceleration and three-axis angular speed detected by orientation sensor 44, controller 41 detects, for example, the orientation, direction of travel, and velocity of frame 10, that is to say, aircraft 100.

GPS communications device 46 detects positional information including a planimetric position and elevation of aircraft 100 by using radio waves received from a satellite. Note that a planimetric position is a position at sea level on the earth. GPS communications device 46 transmits the detected positional information in real time to controller 41. GPS communications device 46 may be configured to wirelessly communicate with steering controller 101 via satellite-based communication.

Wireless communications device 45 wirelessly communicates with steering controller 101. Wireless communications device 45 may be a communications circuit including a communications interface. Moreover, in addition to the function for communicating with steering controller 101, wireless communications device 45 may also include a function for communicating via a mobile communications protocol used by mobile communications systems such as the third-generation mobile communications system (3G), fourth-generation mobile communications system (4G), or LTE (registered trademark). In such cases, wireless communications device 45 may communicate with a communications terminal of, for example, the operator of aircraft 100. The communications terminal may be, for example, a mobile phone, smartphone, smart watch, tablet, or compact personal computer.

Distance sensor 47 measures the distance to and azimuth of an object from frame 10. Distance sensor 47 is configured to measure the distance to and azimuth of an object in a predetermined scanning region of distance sensor 47 from end wall 11c of main body 11 of frame 10. Distance sensor 47 may be configured to measure distance and azimuth by scanning the predetermined scanning region using, for example, radar, laser, lidar (light detection and ranging), light waves, ultrasonic waves, or a camera. Moreover, distance sensor 47 may be configured to measure the distance to and azimuth of an object closest to distance sensor 47 in the predetermined scanning range.

For example, a digital camera or digital video camera that records captured images as digital data can be used as camera 48. Gimbal platform 49 allows for the orientation of camera 48 to be changed freely and supports camera 48. Gimbal platform 49 may be configured such that the movable part is driven by an electric drive device such as a motor or actuator.

Moreover, frame 10 may also be equipped with various other devices such as a lamp, a light-emitting device including, for example, a light-emitting diode (LED), a projector, a speaker, a microphone, and/or any sort of measuring device. The lamp can be used to illuminate the area around aircraft 100. The light-emitting device can be used to indicate the position of aircraft 100 to its surroundings at night or in a dark location, for example. The projector can project an image on the inflated balloon 30 when, for example, balloon 30 is made of a semi-transparent or transparent material. The speaker emits sound, including speech, to the surroundings of aircraft 100. The microphone can pick up sound from the surroundings of aircraft 100.

Controller 41 is for controlling the respective components included in aircraft 100. How controller 41 is implemented is not limited so long as it includes a control function. For example, controller 41 may be implemented as dedicated hardware such as an electronic control unit including, for example, a circuit including a microcomputer. Moreover, for example, controller 41 may be implemented by executing a software program appropriate for each component. In such cases, controller 41 may include an arithmetic processing unit (not illustrated in the drawings) and a storage (not illustrated in the drawings) that stores a control program. Examples of the arithmetic processing unit include a micro processing unit (MPU) and a central processing unit (CPU). Examples of the storage include memory. Controller 41 may be implemented as a single controller that performs centralized control, and may be implemented as a plurality of controllers for performing decentralized control in cooperation with each other.

Controller 41 is configured to control the devices equipped in aircraft 100, including motors 22 of rotor units 20, battery 42, valve 43a of gas canister 43, orientation sensor 44, wireless communications device 45, GPS communications device 46, and distance sensor 47. Furthermore, controller 41 may be configured to control camera 48 equipped on gimbal platform 49.

Controller 41 controls the supply of power to each electrical component of aircraft 100 that uses power from battery 42. Controller 41 also controls the charging of battery 42 using power from a power source external relative to aircraft 100, such as a power grid. Controller 41 may include a converter that controls the charging of battery 42, and may include an inverter that controls the discharging of battery 42.

Furthermore, based on the information obtained by orientation sensor 44, controller 41 detects, for example, the orientation, direction of travel, and velocity of aircraft 100. Based on the detected orientation, direction of travel, and velocity, etc., of aircraft 100, controller 41 controls the operation of motors 22 in the four rotor units 20 such that the operation of aircraft 100 follows command signals received from steering controller 101. Power and communications line 50 (see FIG. 5) that connects controller 41, etc., to motor 22 in each rotor unit 20 is routed through hollow arms 12 of frame 10.

Controller 41 transmits, via wireless communication using wireless communications device 45 or via satellite-based communication using GPS communications device 46, positional information including the planimetric position and elevation of aircraft 100 received in real time from GPS communications device 46, to steering controller 101 in real time or at an appropriate timing. Steering controller 101 may be configured to be capable of satellite-based communication in addition to wireless communication using wireless communications device 45. Moreover, controller 41 may transmit positional information on aircraft 100 to a communications terminal of, for example, the operator of aircraft 100.

Steering controller 101 is configured to be able to receive an input for a flying destination for aircraft 100, and transmits positional information including the planimetric position and elevation of the input flying destination to controller 41 of aircraft 100. Based on the received flying destination positional information and the real time positional information of aircraft 100, controller 41 can implement control for causing aircraft 100 to autonomously fly to the flying destination.

Controller 41 controls operation of valve 43a of gas canister 43. Steering controller 101 is configured to be capable of transmitting a command, such as a command for inflating balloons 30 or a command for deflating balloons 30, to controller 41 of aircraft 100. Controller 41 causes valve 43a to operate in the first valve state upon receipt of a command for inflating balloons 30 from steering controller 101. This places pipes 43b and gas canister 43 in fluid communication, whereby gas stored in gas canister 43 is injected into the four balloons 30 simultaneously, and the four balloons 30 inflate. Note that valve 43a may be configured so as to individually place the four pipes 43b extending from the four balloons 30 in fluid communication with gas canister 43. In such cases, it is possible to inflate only a selection of one or more of the four balloons 30. The selection of the one or more balloons 30 to be inflated may be executed via steering controller 101, and, alternatively, steering controller 101 may transmit a command for inflating the selected one or more balloons 30 to controller 41.

Controller 41 causes valve 43a to operate in the third valve state upon receipt of a command for deflating balloons 30 from steering controller 101. This makes it possible to open the ends of pipes 43b at valve 43a to the atmosphere and release the gas inside balloons 30 to the atmosphere via pipes 43b. Moreover, the filling and dispensing port of gas canister 43 is closed by valve 43a.

Controller 41 causes valve 43a to operate in the second valve state upon receipt of a command for stopping the deflating or inflating of balloons 30 and maintaining the current state of balloons 30 from steering controller 101. This stops the flow of gas in and out of balloons 30. Moreover, the filling and dispensing port of gas canister 43 is closed by valve 43a.

Controller 41 may control operation of valve 43a of gas canister 43 based on the distance between aircraft 100 and an object in the surrounding area of aircraft 100. Controller 41 causes valve 43a of gas canister 43 to operate in the first valve state when a combination of the distance to and azimuth of an object detected by distance sensor 47 is less than or equal to a threshold. In other words, controller 41 causes valve 43a to operate in the first valve state when proximity of an object to aircraft 100 is detected. Here, controller 41 may, for example, revise the threshold by increasing or decreasing the threshold based on a relationship between the current direction of travel or planned direction of travel of aircraft 100 and the detected azimuth of the object.

Moreover, when connected to camera 48, controller 41 controls operation of camera 48. Furthermore, when the movable parts of gimbal platform 49 are driven by an electric drive device, controller 41 may control operation of gimbal platform 49 by controlling the electric drive device. Here, controller 41 may control operation of camera 48 and gimbal platform 49 in accordance with commands received from steering controller 101 that relate to operation of camera 48 and operation of gimbal platform 49.

### (1-1-3. Rotor Unit)

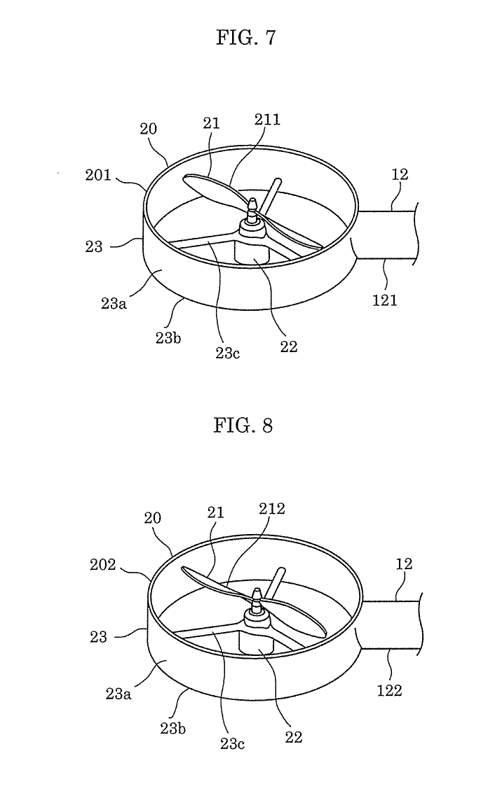

Next, the configuration of rotor units 20 will be described with reference to FIG. 1, FIG. 2, and FIG. 5 through FIG. 8. FIG. 7 is an enlarged perspective view of a first type of rotor unit 201 among the four rotor units 20 included in aircraft 100 illustrated in FIG. 2. FIG. 8 is an enlarged perspective view of a second type of rotor unit 202 among the four rotor units 20 included in aircraft 100 illustrated in FIG. 2.

As illustrated in FIG. 1, FIG. 2, FIG. 7, and FIG. 8, the four rotor units 20 include two first rotor units 201 which are the first type of rotor units and two second rotor units 202 which are the second type of rotor units. As illustrated in FIG. 2 in particular, first rotor units 201 and second rotor units 202 are alternately disposed along the outer circumference of lateral wall 11a of main body 11 of frame 10. In other words, the two first rotor units 201 are respectively provided to, from among the four arms 12 of frame 10, the two first arms 121 positioned opposite each other across main body 11. Furthermore, the two second rotor units 202 are respectively provided to, from among the four arms 12, the two second arms 122 positioned opposite each other across main body 11.

As illustrated in FIG. 7 and FIG. 8, first rotor units 201 and second rotor units 202 each have the same configuration except for the configuration of propeller 21. Rotor frames 23 of rotor units 201 and 202 each include cylindrical part 23b having a slim structure in the axial direction, and a plurality of rod-shaped support arms 23c that extend radially inward from the inner circumferential surface of cylindrical part 23b. Cylindrical part 23b and support arms 23c are integral. Note that in this embodiment, each rotor frame 23 includes three support arms 23c, but the number of support arms 23c is not limited to this example. Motors 22 of rotor units 201 and 202 are each disposed in the inner space defined by cylindrical part 23b and supported in a position on the central axis of cylindrical part 23b by support arms 23c so as to be fixed to cylindrical part 23b. Moreover, the outer circumferential surface of cylindrical part 23b of each rotor unit 201 and 202 defines outer circumferential surface 23a, and an end of arm 12 is joined to outer circumferential surface 23a.

First propeller 211, which is a first type of propeller among propellers 21, is attached to the rotary drive shaft of motor 22 in first rotor unit 201. Second propeller 212, which is a second type of propeller among propellers 21, is attached to the rotary drive shaft of motor 22 in second rotor unit 202. Each first propeller 211 and second propeller 212 is disposed inside a different cylindrical part 23b such that its axis of rotation is aligned with the axis of cylindrical part 23b. Each first propeller 211 and second propeller 212 is disposed so as to be positioned above motor 22 when aircraft 100 is in a normal flying state. In this embodiment, each first propeller 211 and second propeller 212 is a two-bladed propeller. Note that the number of blades in each of first propeller 211 and second propeller 212 is not limited to two.

Moreover, the blades in first propeller 211 and the blades in second propeller 212 twist in opposite directions. Stated differently, the blades in first propeller 211 and the blades in second propeller 212 have inverted structures. Accordingly, when first propeller 211 and second propeller 212 rotate in a clockwise direction in FIG. 2, first propeller 211 generates upward thrust, and second propeller 212 generates downward thrust. Similarly, when first propeller 211 and second propeller 212 rotate in a counter-clockwise direction, first propeller 211 generates downward thrust, and second propeller 212 generates upward thrust.

With first rotor units 201 and second rotor units 202 configured as described above, both when causing aircraft 100 to ascend and when causing aircraft 100 to descend, first propellers 211 and second propellers 212 rotate in opposite directions. With this, the counter torque imparted on frame 10 when first propellers 211 are rotationally driven and the counter torque imparted on frame 10 when second propellers 212 are rotationally driven cancel each other out.

Note that in this embodiment, one propeller 21 is exemplified as being provided to the rotary drive shaft of motor 22 in each rotor unit 20, but two or more propellers 21 may be provided. When two propellers 21 are provided to the rotary drive shaft of motor 22, the two propellers 21 may be configured so as to rotate in opposite directions. In other words, the two propellers 21 may be contra-rotating propellers. In such cases, the counter torque that these two propellers 21 impart on rotor frame 23 cancel each other out.

As illustrated in FIG. 5 and FIG. 6, liquid surface sensors 51 are attached to the bottom end of rotor frame 23 of each rotor unit 20. The bottom end of rotor frame 23 is one end among both ends along the axis of the cylindrical rotor frame 23, and is the lower end when aircraft 100 is in its normal flying orientation. Liquid surface sensor 51 is a contact sensor or a non-contact sensor that detects proximity to or contact with the surface of a liquid such as water. For example, liquid surface sensor 51 may detect proximity to the surface of a liquid when the distance to the surface of the liquid is a predetermined value or less. The type of liquid surface sensor 51 may be any given type, such as optical, ultrasonic, capacitance, electrical conductivity, piezo resonance, or magnetic. Liquid surface sensor 51 may detect proximity to the surface of a liquid using a camera that captures an image of the surface of the liquid. Liquid surface sensor 51 is configured to transmit, to controller 41 of frame 10, a result of the detection of proximity to or contact with the surface of a liquid. Note that liquid surface sensor 51 may be disposed on frame 10.

### (1-1-4. Balloon)

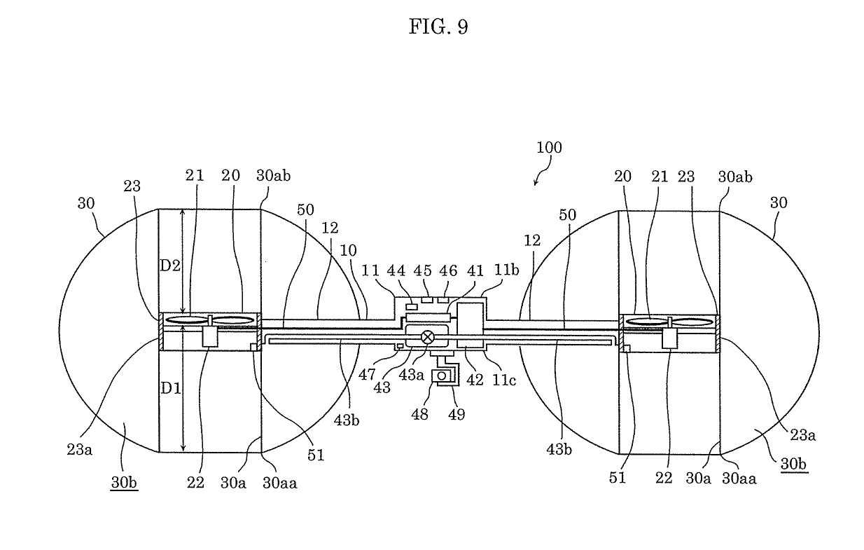

Next, the configuration of balloons 30 will be described with reference to FIG. 1 through FIG. 5 and FIG. 9. FIG. 9 is a cross-sectional view of aircraft 100 taken at line IX-IX in FIG. 4, and illustrates aircraft 100 illustrated in FIG. 5 when in a state in which balloons 30 are inflated. Balloons 30 are attached to rotor frames 23 of rotor units 20 in aircraft 100. Each balloon 30 has a bag-shaped structure and defines therein chamber 30b. When chamber 30b changes in volumetric capacity by being inflated or deflated, balloon 30 also inflates or deflates. Each balloon 30 is disposed on outer circumferential surface 23a of a different rotor frame 23 so as to surround the entire circumference of outer circumferential surface 23a. Balloons 30 are typically disposed on rotor frames 23 in a deflated and folded state so as to reduce the volume of chambers 30b. In other words, balloons 30 are stored. In this state, each balloon 30 has an annular external shape. When gas is injected into chambers 30b from gas canister 43, balloons 30 can inflate so as to have an internal volume that is a few times or tens of times the internal volume when in a stored state. Balloons 30 cover the lateral surfaces of rotor frames 23 of rotor units 20 when inflated.

Balloons 30 are made of a material that is in sheet form and is flexible. For example, balloons 30 may be made of a supple sheet material, such as polyvinyl chloride. Unwoven fabric may be used as the above-described sheet material for balloons 30. Using a sheet material such as described above makes it easy to fold balloons 30 when being stored. Furthermore, balloons 30 may be made of an elastic sheet material, such as polyurethane. This makes it easy to store balloons 30 since balloons 30 themselves deflate so as to shrink in volume when gas is not filled therein. Still furthermore, balloons 30 may be made of a highly stretchable sheet material, such as rubber. This makes it easy to reduce the space occupied by balloons 30 when storing balloons 30 since balloons 30 themselves deflate so as to significantly shrink in volume when gas is not filled therein. Balloons 30 that are made of sheet material as described above and injected and inflated with gas can function as shock absorbers that act as cushions for aircraft 100.

As illustrated in FIG. 3, FIG. 4, and FIG. 9, in this embodiment, when balloons 30 are inflated by being injected with gas, each has an external shape of an ellipsoid. More specifically, balloons 30 have an external shape of an ellipsoid defined by rotating an ellipse about its minor axis. The shape of each balloon 30 is such that its height in the up-and-down direction along the minor axis gradually decreases in a direction from the central region where the minor axis of the ellipsoid is located toward the edge of the ellipsoid at the end of the major axis. With this, since balloons 30 each have a streamline shape when viewed from the lateral side, it is possible to reduce air resistance.

Cylindrical through-hole 30a passes through each balloon 30 along the minor axis of the ellipsoid. When inflated, chamber 30b of balloon 30 defines a single continuous space that circumferentially surrounds through-hole 30a on the inner side of the sheet material. The entire rotor unit 20 is disposed within through-hole 30a. Rotor unit 20 is disposed such that the axis of rotation of propeller 21 and the rotary drive shaft of motor 22 are aligned with the axis of through-hole 30a. In other words, rotor unit 20 is entirely laterally covered by balloon 30. Each arm 12 of frame 10 extends from the inner circumferential wall surface of through-hole 30a, and passes through and out of balloon 30. Chamber 30b of balloon 30 is separated from rotor frame 23 of rotor unit 20 and arm 12 by the sheet material forming balloon 30. Accordingly, since rotor unit 20 is disposed in through-hole 30a whose ends are both open, even when balloon 30 is inflated, when propeller 21 is rotating, rotor unit 20 can thrust aircraft 100 by generating thrust in a direction from one open end 30aa of through-hole 30a to the other open end 30ab, or in the opposite direction. When aircraft 100 is in its normal flying orientation, open end 30aa is located on the bottom end of through-hole 30a, and open end 30ab is located on the top end of through-hole 30a.

Note that the external shape of balloon 30 when inflated is not limited to an ellipsoid. The external shape of balloon 30 when inflated may be, for example, a sphere, a columnar shape, a polyhedron, or a donut shape, may be any combination of at least two of an ellipsoid, a sphere, a columnar shape, a polyhedron, and a donut shape, and may be any other shape. Furthermore, balloon 30 need not have a shape that surrounds the entire circumference of outer circumferential surface 23a of rotor frame 23; balloon 30 may have a shape that conforms to a portion of outer circumferential surface 23a. Alternatively, balloon 30 may not cover rotor frame 23, but rather be attached directly or indirectly to or disposed on rotor unit 20. The external shape of balloon 30 when inflated is preferably a shape defined by aerodynamic, smooth surfaces.

As illustrated in FIG. 9, in this embodiment, the position of rotor unit 20 in through-hole 30a is set as follows. Rotor unit 20 is positioned such that axial distance D1 of through-hole 30a from open end 30aa of through-hole 30a to propeller 21 of rotor unit 20 is greater than or equal to the inner diameter of through-hole 30a, and axial distance D2 of through-hole 30a from open end 30ab of through-hole 30a to propeller 21 is greater than or equal to the inner diameter of through-hole 30a. In other words, through-hole 30a has an axial length that satisfies the above-described conditions for distances D1 and D2.

Note that inner diameter dimensions of through-hole 30a that are compared to distances D1 and D2 may be the inner diameter dimensions at any section of through-hole 30a; for example, they may be the inner diameter dimensions of open ends 30aa and 30ab. Alternatively, what is compared to distances D1 and D2 may be the outer diameter of rotor frame 23 of rotor unit 20, that is to say, the outer diameter of cylindrical part 23b (see FIG. 7 and FIG. 8). In such cases, rotor unit 20 is arranged such that distances D1 and D2 are greater than or equal to the outer diameter of cylindrical part 23b. Moreover, when the edges of the inner perimeter of open ends 30aa and 30ab of through-hole 30a are rounded or chamfered, distances D1 and D2 may be the distances from propeller 21 of rotor unit 20 to planes extending across open ends 30aa and 30ab from the outside of through-hole 30a. When the planes extending across open end 30aa and 30ab are inclined relative to planes perpendicular to the axis of through-hole 30a, distances D1 and D2 may each be a distance from propeller 21 to a point closest to propeller 21 on the plane.

When through-hole 30a has a non-circular cross section, the inner diameter dimensions that are compared to distances D1 and D2 may be, from among the wide variety of crosswise dimensions of cross sections perpendicular to the axis of through-hole 30a, the greatest crosswise dimension. Moreover, distances D1 and D2 may be distances from the center of rotor frame 23 in the axial direction of through-hole 30a, to open ends 30aa and 30ab, respectively.

In this embodiment, in order to position rotor unit 20 in through-hole 30a in balloon 30 as described above, the length of through-hole 30a can be set based on the inner diameter set for through-hole 30a. As described above, when inflated, balloon 30 laterally covers rotor unit 20, across a region exceeding the height of rotor unit 20 along the axis of through-hole 30a. Balloon 30 configured in such a manner as to, when a foreign object, such as a person's hand, vegetation, or an object contacts balloon 30 in the vicinity of open end 30aa or 30ab of through-hole 30a, inhibit foreign objects larger than the inner diameter of through-hole 30a from entering through-hole 30a. In cases in which a foreign object enters through-hole 30a, the size of the section of the foreign object that is inside through-hole 30a is less than or equal to the inner diameter of through-hole 30a. Accordingly, it is possible to prevent such foreign object from contacting propeller 21, which is located at a depth greater than or equal to the inner diameter through-hole 30a in through-hole 30a. Moreover, when rotor unit 20 is impacted or when rotor unit 20 breaks down, even if the rotary drive shaft of propeller 21 of rotor unit 20 rotates 90 degrees relative to the axis of through-hole 30a, rotor unit 20 can be inhibited from protruding out of through-hole 30a. Accordingly, balloon 30 can laterally cover rotor unit 20 to a degree such that rotor unit 20 is not likely to contact an object.

### (1-2. Operation of Aircraft)

Next, operation of aircraft 100 will be described. As illustrated in FIG. 1 through FIG. 5 and FIG. 9, aircraft 100 flies according to commands received from steering controller 101. By controller 41 of aircraft 100 controlling rotation of propellers 21 of rotor units 20 in accordance with commands for flying maneuvers received from steering controller 101, such as ascend, descend, hover, go forward, go backward, turn right, turn left, strafe right, strafe left, change pitch, etc., controller 41 of aircraft 100 can control the orientation of aircraft 100 detected by orientation sensor 44 and implement the various flying maneuvers. Moreover, controller 41 of aircraft 100 can control image capturing by camera 48 and change the orientation of camera 48 via gimbal platform 49, in accordance with commands received from steering controller 101. Controller 41 of aircraft 100 can also operate various devices, including lamps, light-emitting devices, projectors, speakers, microphones, and various types of gauges, in accordance with commands received from steering controller 101.

Controller 41 of aircraft 100 controls valve 43a in accordance with commands received from steering controller 101, such as commands for inflating, deflating, or maintaining the current inflation state of balloons 30, so as to inject gas into balloons 30, discharge gas from balloons 30, or stop injection and discharging of gas to and from balloons 30.

While aircraft 100 is operating, controller 41 of aircraft 100 transmits, to steering controller 101, positional information detected by GPS communications device 46, including the planimetric position and elevation of aircraft 100. Controller 41 receives a command regarding a flying destination from steering controller 101, and autonomously flies aircraft 100 to the flying destination based on positional information on the received flying destination and positional information of aircraft 100 detected by GPS communications device 46. Furthermore, in addition to the positional information on the flying destination, controller 41 of aircraft 100 can receive a command to inflate balloons 30 at the flying destination from steering controller 101. In such cases, the elevation of aircraft 100 at the time of inflating balloons 30 at the flying destination may be specified individually. Controller 41 automatically inflates balloons 30 when aircraft 100 arrive at the flying destination.

When the gas injected into balloons 30 has a lower specific gravity than the atmosphere, balloons 30 function as buoyant body for aircraft 100 relative to the air and assist in the ascension of aircraft 100. When the gas injected into balloons 30 has a specific gravity that is greater than or equal to the atmosphere, balloons 30 function as a buoyant body for aircraft 100 when in or on a liquid such as water or sea water. In such cases, balloons 30 cause aircraft 100 to float on a body of water such as the ocean, making it possible for aircraft 100 to function as a floating body that can be used for rescue purposes. Furthermore, as a result of rotor units 20 functioning as screws, aircraft 100 can function as a rescue craft.

Controller 41 of aircraft 100 can automatically inflate balloons 30 when a combination of the distance to and azimuth of an object in the surrounding area, from main body 11 of aircraft 100, as detected by distance sensor 47, is less than or equal to a threshold. For example, controller 41 inflates balloons 30 when the distance from main body 11 to an object below main body 11 is less than or equal to a first threshold. This makes it possible to land aircraft 100 on a liquid, such as water or sea water. Moreover, even when landing on land, by inflating balloons 30 beforehand, in addition to being able to reduce impact when landing on land, it is possible for aircraft 100 to reduce damage imparted to, for example, a person on land in case of contact with the person. Moreover, for example, controller 41 inflates balloons 30 when the distance from main body 11 to an object ahead in the direction of travel of aircraft 100 is less than or equal to a second threshold. This makes it possible to reduce damage received upon aircraft 100 contacting an object.

Controller 41 of aircraft 100 inflates balloons 30 when liquid surface sensor 51 detects proximity to or contact with a surface of a liquid such as water or sea water. This makes it possible to land aircraft 100 on a liquid, such as water or sea water, and further for aircraft 100 to function as a buoyant body capable of being used for rescue. Since balloons 30 are inflated upon or immediately before landing on water, aircraft 100 can rapidly descend to the water.

### (1-3. Advantageous Effects, etc.)

As described above, aircraft 100 according to the present disclosure includes: a plurality of rotor units 20 each including propeller 21 and motor 22 that drives propeller 21; balloons 30, as a bag-shaped body, that respectively include chambers 30b; and an gas canister 43 and valve 43a that inject gas into chamber 30b to inflate balloons 30. Balloons 30 cover the plurality of rotor units 20 when inflated.

With the above-described configuration, aircraft 100 can deflate the bag-shaped balloons 30 when flying. Moreover, aircraft 100 can inflate balloons 30 via gas canister 43 and valve 43a, and each balloon 30 can function as a shock absorber and/or buoyant body. The bag-shaped balloons 30 can be stored in rotor units 20 when deflated, in a folded, compact state. Accordingly, when balloons 30 are deflated, it is possible to inhibit a reduction in the mobility of aircraft 100 when flying resulting from air resistance. Moreover, by inflating balloons 30 when, for example, landing, balloons 30 have a cushioning effect and thus, in case of contact with a person, etc., on the landing surface or in the surrounding area, can reduce damage to both aircraft 100 and the person. In particular, since balloons 30 are provided to rotor units 20, which include propellers 21, it is possible to reduce contact with propellers 21. Moreover, the configuration of balloons 30 covering rotor units 20 includes a configuration of balloons 30 covering the entirety of rotor units 20, such as is the case in this embodiment, and a configuration of balloons 30 covering part of rotor units 20.

Furthermore, in aircraft 100 according to the present disclosure, balloons 30 are provided to rotor units 20. With the above-described configuration, balloons 30 function as shock absorbers that directly work on rotor units 20.

Aircraft 100 according to the present disclosure includes controller 41 that controls valve 43a, and when controller 41 determines that a predetermined condition has been met, controller 41 causes valve 43a to inject gas into chambers 30b of balloons 30 in a deflated state. With the above-described configuration, balloons 30 can be inflated when necessary by controller 41.

Aircraft 100 according to the present disclosure includes GPS communications device 46 that detects the position of aircraft 100. Controller 41 causes valve 43a to inject gas into chambers 30b when the position of aircraft 100 detected by GPS communications device 46 is a predetermined position. With the above-described configuration, balloons 30 can be automatically inflated when aircraft 100 reaches a predetermined position. Note that a predetermined position may include only planimetric positions, and may include planimetric positions and elevations.

Aircraft 100 according to the present disclosure includes distance sensor 47 that detects a distance between aircraft 100 and an object in the surrounding area of aircraft 100. Controller 41 causes valve 43a to inject gas into chambers 30b when the distance between aircraft 100 and an object in the surrounding area of aircraft 100 detected by distance sensor 47 is a predetermined distance or shorter. With the above-described configuration, balloons 30 can be automatically inflated when in proximity to an object in the surrounding area of aircraft 100, and function as shock absorbers for aircraft 100.

Aircraft 100 according to the present disclosure includes liquid surface sensor 51 that detects the surface of a liquid. Controller 41 causes valve 43a to inject gas into chambers 30b when liquid surface sensor 51 detects proximity to or contact with the surface of the liquid. With the above-described configuration, balloons 30 can be automatically inflated immediately before or at the same time as aircraft 100 lands on a liquid surface, and function as buoyant bodies for aircraft 100. As a result, aircraft 100 can be prevented from sinking in the liquid, and, furthermore, can function as a buoyant body capable of being used for rescue on a body of water such as the ocean.

### Embodiment 2

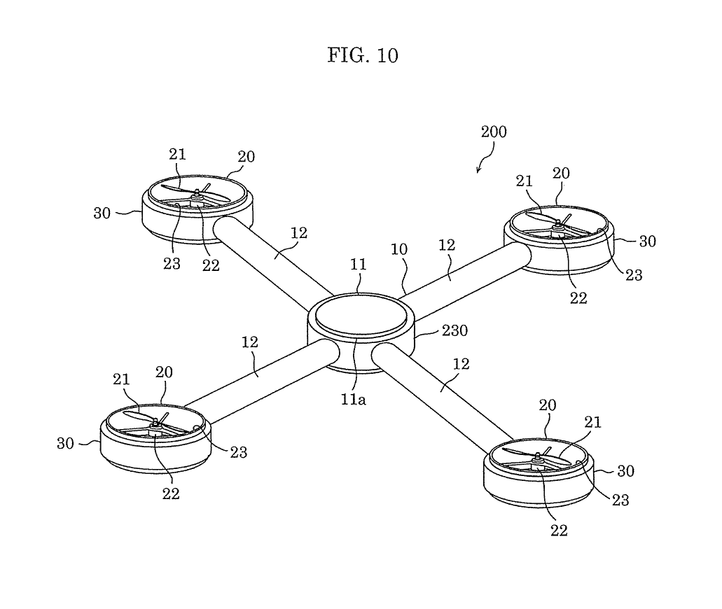

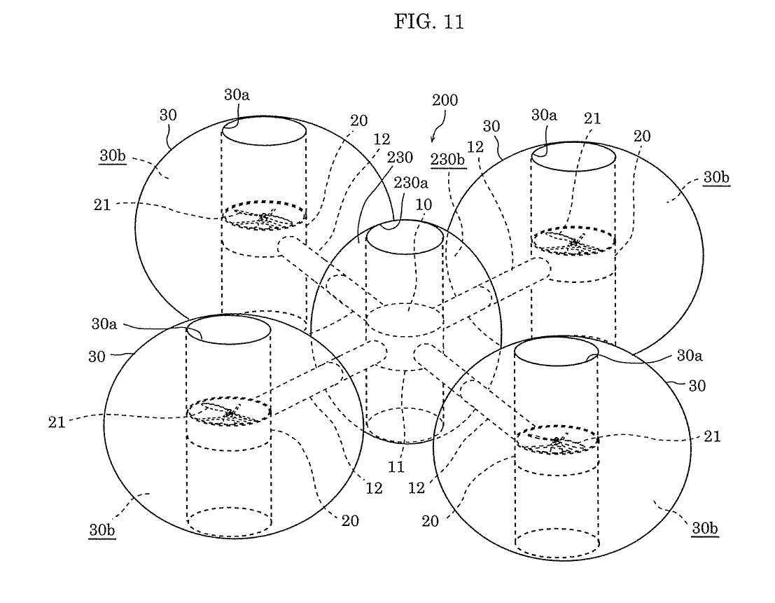

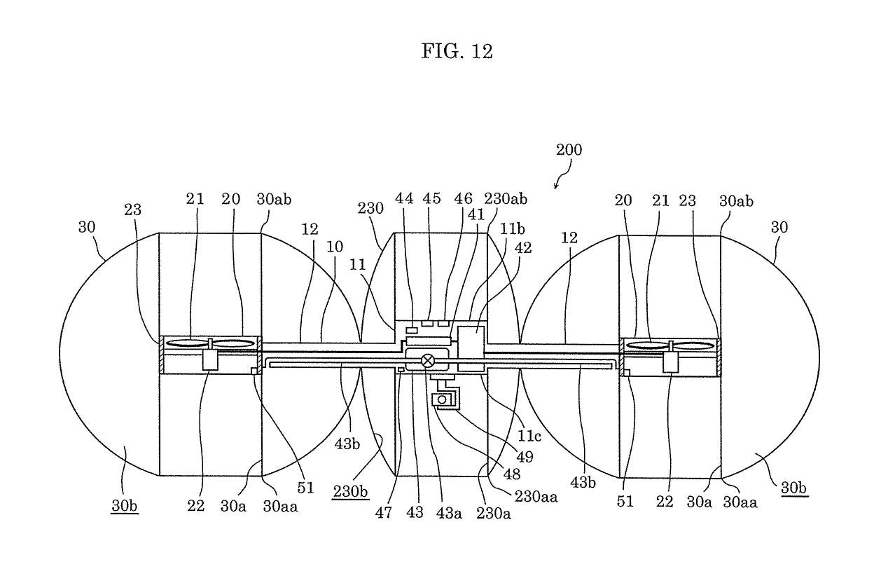

Next, aircraft 200 according to Embodiment 2 will be described with reference to FIG. 10 through FIG. 12. FIG. 10 is a perspective view of aircraft 200 according to Embodiment 2, similar to the view of FIG. 1. FIG. 11 is a perspective view of aircraft 200 according to Embodiment 2, similar to the view of FIG. 3. FIG. 12 is a cross-sectional view of aircraft 200 according to Embodiment 2, similar to the view of FIG. 9. In the following description of the embodiment, elements that have the same reference numerals as in previously referenced drawings indicate the same or similar elements, and as such, detailed description thereof is omitted. Furthermore, points that are similar to Embodiment 1 are omitted.

Aircraft 200 has a configuration achieved by adding second balloon 230, which is a bag-shaped body, to main body 11 of frame 10 in aircraft 100 according to Embodiment 1. Second balloon 230 is made of the same material as balloons 30, which are first balloons. As illustrated in FIG. 10, a single second balloon 230, which is a bag-shaped body, is attached to the outer circumferential surface of lateral wall 11a of main body 11 of frame 10 so as to circumvent the four arms 12 and surround said outer circumferential surface. Second balloon 230 is equipped on main body 11 typically in a deflated, folded, and stored state, and has an annular external shape. As illustrated in FIG. 12, second balloon 230 is connected to gas canister 43 via pipes not illustrated in the drawing and valve 43a. When gas in gas canister 43 is injected into chamber 230b of second balloon 230, second balloon 230 can inflate so as to have an internal volume that is a few times or tens of times the internal volume when in a stored state. Moreover, when inflated, second balloon 230 covers the outer circumferential surface of lateral wall 11a of main body 11. In other words, main body 11 is entirely laterally covered by second balloon 230, but this example is not limiting; main body 11 may be partially covered. Alternatively, second balloon 230 may not cover frame 10 including main body 11, but rather be attached directly or indirectly to or disposed on frame 10. Here, second balloon 230 is one example of the second bag-shaped body.

Valve 43a may be configured to supply the gas in gas canister 43 to the four first balloons 30 and the single second balloon 230 simultaneously, and may be configured to supply the gas to the four first balloons 30 and the single second balloon 230 individually. Operation of valve 43a that controls the inflation of second balloon 230 is controlled by controller 41 based on, for example, a command from steering controller 101.

As illustrated in FIG. 11 and FIG. 12, when second balloon 230 is inflated by being injected with gas, it has an external shape of an ellipsoid. More specifically, second balloon 230 has an external shape of an ellipsoid defined by rotating an ellipse about its major axis. Second balloon 230 has a cylindrical through-hole 230a. Through-hole 230a passes through second balloon 230 along the major axis of the ellipsoid, and opens at open ends 230aa and 230ab. When inflated, chamber 230b of second balloon 230 defines a single continuous space that circumferentially surrounds through-hole 230a on the inner side of the sheet material. The axis of through-hole 230a of second balloon 230 is aligned with the axes of through-holes 30a of first balloons 30. In this embodiment, the height of second balloon 230 along the axes of through-holes 30a and 230a is approximately the same as that of first balloon 30. This gives second balloon 230 a shock absorbing function in the axial directions of through-holes 30a and 230a, just like first balloons 30.

Note that when inflated by receiving an injection of gas, second balloon 230 may contact first balloons 30 such that first balloons 30 and second balloon 230 provide complete coverage without exposing arms 12. In such cases, when aircraft 200 contacts an object or person, for example, since a shock absorbing function is provided to arms 12 in addition to rotor units 20 and main body 11 of frame 10 in aircraft 200, it is possible to reduce damage to both aircraft 200 and the object or person contacted.

The entirety of main body 11 of frame 10 is positioned in through-hole 230a, and main body 11 is oriented such that the axis of the cylindrical lateral wall 11a and the axis of through-hole 230a are aligned. In other words, main body 11 is entirely laterally covered by second balloon 230. Each arm 12 of frame 10 extends from the inner circumferential wall surface of through-hole 230a, and passes through and out of second balloon 230. Chamber 230b is separated from main body 11 and arms 12 by the sheet material forming second balloon 230.

Second balloon 230 may be inflated in approximately the same time period as first balloons 30 are inflated. Second balloon 230 may be inflated at the same time as first balloons 30, and may be inflated at a slight difference in time relative to the inflation of first balloons 30. When inflated at different times, second balloon 230 may be inflated after first balloons 30. This makes it possible to delay the lateral covering of camera 48 by second balloon 230 so that camera 48 can continue capturing images for longer.

Furthermore, second balloon 230 may be inflated at an arbitrary difference in time relative to first balloons 30. For example, when aircraft 200 lands at a position on the surface of a liquid, such as water or sea water, in the vicinity of which an obstruction such as a bridge is present, aircraft 200 may inflate first balloons 30 when in proximity to the obstruction and subsequently inflate second balloon 230 when in proximity to the liquid surface. With this, when in proximity the obstruction, aircraft 200 reduces the risk of damage to both aircraft 200 and the obstruction caused by contact with the obstruction, as a result of first balloon 30 covering the area surrounding rotor unit 20, and maintains some degree of mobility of aircraft 200. Moreover, as a result of aircraft 200 inflating second balloon 230 when in proximity to the liquid surface, when a person or object is present at the landing position, this reduces the risk of possible damage to the person or object from contact.

Moreover, other components and operations of aircraft 200 according to Embodiment 2 are the same as described in Embodiment 1, and as such, description thereof is omitted. Furthermore, aircraft 200 according to Embodiment 2 achieves the same advantageous effects as aircraft 100 according to Embodiment 1. Furthermore, aircraft 200 according to Embodiment 2 includes frame 10 that supports the plurality of rotor units 20, and in aircraft 200, first balloons 30 cover rotor units 20 when inflated and second balloon 230 covers frame 10 when inflated. With the above-described configuration, since second balloon 230 that covers frame 10 when inflated is provided in addition to first balloons 30 that cover rotor units 20 when inflated, the buoyancy of aircraft 200 provided by balloons 30 and 230 increases. Furthermore, balloons 30 and 230 make it possible to provide a shock absorbing function to frame 10 in addition to rotor units 20. Moreover, the configuration of second balloon 230 covering frame 10 includes a configuration of second balloon 230 covering frame 10 in entirety and a configuration of second balloon 230 covering part of frame 10.

### Other Embodiments

The above embodiments have been presented as examples of techniques according to the present disclosure. However, the techniques according to the present disclosure are not limited to the above embodiments; various changes, substitutions, additions, omissions, etc., may be made to the embodiments. Moreover, components included in the above-described embodiments and components included in the other embodiments described below may be combined to achieve new embodiments. Next, other embodiments will be exemplified.

In aircrafts 100 and 200 according to Embodiments 1 and 2 described above, a single first balloon 30 is provided to each of four rotor units 20, but this example is not limiting; each and every rotor unit 20 need not be provided with first balloon 30.

Aircrafts 100 and 200 according to Embodiments 1 and 2 described above include individual first balloons 30 each provided to a different one of the four rotor units 20. However, at least two of the four first balloons 30 may be integral. In such cases, chambers 30b of the integral first balloon 30 may or may not be in fluid communication with each other. Moreover, second balloon 230 may be integral with at least one of the four first balloons 30. In such cases, chamber 30b and chamber 230b of the integral first and second balloons 30 and 230 may or may not be in fluid communication with each other.

In aircrafts 100 and 200 according to Embodiments 1 and 2 described above, first balloon 30 laterally covers rotor unit 20 from the outside, and second balloon 230 laterally covers main body 11 of frame 10 from the outside, but this example is not limiting. First balloons 30 and second balloon 230 may be arranged in any manner.

For example, first balloon 30 may cover rotor unit 20 from the inside instead of from the outside, and may cover rotor unit 20 from both the outside and inside. Moreover, first balloon 30 may be disposed below and/or above rotor unit 20, may be disposed across the bottom and lateral side of rotor unit 20, may be disposed across the top and lateral side of rotor unit 20, and may be disposed across the top, lateral side, and bottom of rotor unit 20. Moreover, second balloon 230 may be disposed below and/or above main body 11, may be disposed across the bottom and lateral side of main body 11, may be disposed across the top and lateral side of main body 11, and may be disposed across the top, lateral side, and bottom of main body 11. Moreover, second balloon 230 may be provided to arms 12 of frame 10 rather than to main body 11, and may be arranged from main body 11 across arms 12.

Moreover, when aircrafts 100 and 200 according to Embodiments 1 and 2 are used for rescue purposes on a body of water such as the ocean, when inflated, first balloons 30 may be configured to cover the top and bottom of rotor units 20 in addition to laterally, and second balloon 230 may be configured to cover the top and bottom of main body 11 in addition to laterally. This makes it possible for aircrafts 100 and 200 to land on water more safely.

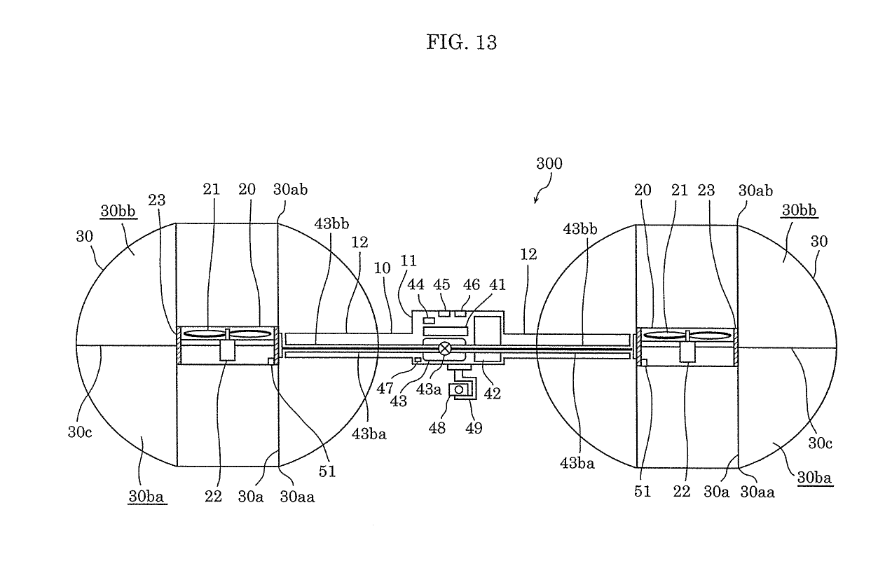

In aircrafts 100 and 200 according to Embodiments 1 and 2 described above, a single first balloon 30 is provided to each of four rotor units 20, but two or more balloons may be provided to each rotor unit 20. Moreover, a single second balloon 230 is provided to main body 11 of frame 10, but two or more balloons may be provided to main body 11 of frame 10. Alternatively, for example, as illustrated in FIG. 13, a single chamber 30b in first balloon 30 may be divided into two or more chambers. FIG. 13 is a cross-sectional view of a variation of aircraft 100 according to Embodiment 1, similar to the view of FIG. 9. In aircraft 300 illustrated in FIG. 13, the chamber in each first balloon 30 is divided into two upper and lower chambers 30ba and 30bb by partition 30c extending in a plane substantially perpendicular to the axis of through-hole 30a. Chambers 30ba and 30bb are not in fluid communication with each other, and are, but are not limited to being, substantially equal in volume. Chambers 30ba and 30bb are each connected to valve 43a via pipes 43ba and 43bb, configured so as to inflate and deflate individually. Partition 30c is located adjacent to rotor frame 23 of rotor unit 20. The buoyancy of first balloon 30 can be adjusted by individually inflating chambers 30ba and 30bb. Similarly, chamber 230b of second balloon 230 provided to frame 10 may be divided into two or more chambers.

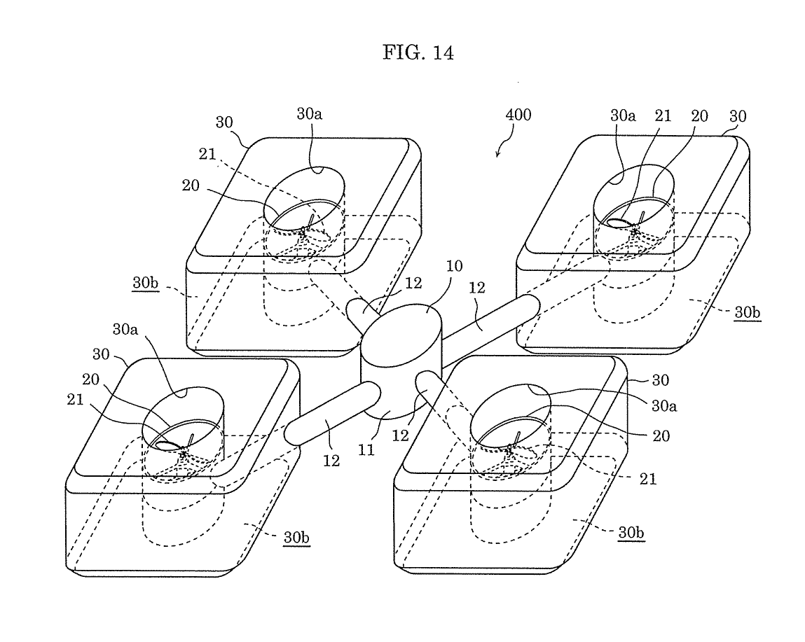

In aircrafts 100 and 200 according to Embodiments 1 and 2 described above, when inflated, first balloons 30 and second balloon 230 are exemplified as having an external shape of an ellipsoid, but may be any shape. Furthermore, in first balloons 30 and second balloon 230, the axial height of through-holes 30a and 230a need not be related to the diameter of through-hole 30a and position of propeller 21 of rotor unit 20. For example, when inflated, first balloons 30 may have a flattened cuboid external shape, such as aircraft 400 illustrated in FIG. 14. Furthermore, the external shape of second balloon 230 when inflated may be the same as first balloons 30. FIG. 14 is a perspective view of aircraft 400 according to another variation of aircraft 100 according to Embodiment 1, similar to the view of FIG. 3. Moreover, for example, when aircrafts 100 and 200 are used for rescue purposes on a body of water such as the ocean, first balloons 30 and second balloon 230 may be configured to have a shape when inflated that is easy for a person to grab, such as a ring shape or a shape including a handle. Alternatively, when inflated, first balloons 30 may collectively have the shape of a small boat, and, when inflated, first balloons 30 and second balloon 230 may collectively have the shape of a small boat. In such cases, rotor units 20 may function as screws.

In aircrafts 100 and 200 according to Embodiments 1 and 2 described above, first balloons 30 and second balloon 230 are inflated using gas filled in gas canister 43, but this example is not limiting. First balloons 30 and second balloon 230 may be inflated by pneumatic pressure from a device equipped in aircraft 100, such as an air pump or an air compressor. Alternatively, first balloons 30 and second balloon 230 may be inflated by using gas generated by a chemical reaction from combustion of a substance, similar to an airbag device in an automobile, and may be inflated by using gas generated by some other type of chemical reaction. Moreover, a plurality of gas canisters 43 may be used. For example, gas canisters 43 may be respectively provided to first balloons 30 and second balloon 230, and more than one gas canister 43 may be provided to each first balloon 30. In such cases, first balloons 30 and second balloon 230 can be inflated faster.

In aircrafts 100 and 200 according to Embodiments 1 and 2 described above, the supply of gas from gas canister 43 to first balloons 30 and second balloon 230 is achieved by switching operations performed by valve 43a, but this example is not limiting. The gas in gas canister 43 may be supplied to each balloon by a water-soluble device, such as a pill, that holds back a needle capable of piercing gas canister 43, dissolving in water, allowing the needle to pierce gas canister 43, like a configuration used in life jackets.

Aircrafts 100 and 200 according to Embodiments 1 and 2 described above are each exemplified as, but not limited to, including four rotor units 20; each may include one or more rotor units 20.

In Embodiments 1 and 2, aircrafts 100 and 200 are exemplified as being used for rescue purposes on a body of water such as the ocean, but aircrafts 100 and 200 may be used in any kind of application. For example, aircrafts 100 and 200 may be used in a variety of applications including, photography, transportation, and entertainment. The dramatic effect of the inflation of first balloons 30 and second balloon 230 allows for aircrafts 100 and 200 to be used for entertainment purposes.

The above embodiments have been presented as examples of techniques according to the present disclosure. The accompanying drawings and the detailed description are provided for this purpose.

Therefore, the components described in the accompanying drawings and the detailed description include, in addition to components essential to overcoming problems, components that are not essential to overcoming problems but are included in order to exemplify the techniques described above. Thus, those non-essential components should not be deemed essential due to the mere fact that they are illustrated in the accompanying drawings and described in the detailed description.

The above embodiments are for providing examples of the techniques according to the present disclosure, and thus various modifications, substitutions, additions, and omissions are possible in the scope of the claims and equivalent scopes thereof.

### INDUSTRIAL APPLICABILITY

As described above, the present disclosure is applicable to an aircraft including a rotor unit and a balloon.

What is claimed is:

1. An aircraft, comprising:
a plurality of rotor units each including a propeller and a motor that drives the propeller;
a bag-shaped body including a chamber; and
an injector that injects gas into the chamber to inflate the bag-shaped body,
wherein the bag-shaped body covers at least one of the plurality of rotor units when inflated.

2. The aircraft according to claim 1, wherein
the bag-shaped body is provided to at least one of the plurality of rotor units.

3. The aircraft according to claim 1, further comprising:
a frame that supports the plurality of rotor units,
wherein the bag-shaped body includes a first bag-shaped body that covers at least one of the plurality of rotor units when inflated and a second bag-shaped body that covers the frame when inflated.

4. The aircraft according to claim 3, wherein
the second bag-shaped body is provided to the frame.

5. The aircraft according to claim 1, further comprising:
a controller that controls the injector,
wherein when the controller determines that a predetermined condition has been met, the controller causes the injector to inject gas into the chamber of the bag-shaped body in a deflated state.

6. The aircraft according to claim 5, further comprising:
a positioning device that detects a position of the aircraft,
wherein the controller causes the injector to inject gas into the chamber when the position of the aircraft detected by the positioning device is a predetermined position.

7. The aircraft according to claim 5, further comprising:
a distance sensor that detects a distance between the aircraft and an object in a surrounding area of the aircraft,
wherein the controller causes the injector to inject gas into the chamber when the distance detected by the distance sensor is a predetermined distance or shorter.

8. The aircraft according to claim 5, further comprising:
a liquid surface sensor that detects a surface of a liquid,
wherein the controller causes the injector to inject gas into the chamber when the liquid surface sensor detects proximity to or contact with the surface of the liquid.
